(19) United States
(12) Patent Application Publication
(10) Pub. No.: US 2017/0320081 A1
(43) Pub. Date: Nov. 9, 2017

(54) Pressure washer with cool 100% bypass device and method

(71) Applicant: David Heuckeroth, Thomaston, CT (US)

(72) Inventor: David Heuckeroth, Thomaston, CT (US)

(21) Appl. No.: 15/146,894

(22) Filed: May 5, 2016

(51) Int. Cl. B05B 9/03; B08B 3/02

(52) U.S. Cl. CPC B05B 9/03; B08B 3/026

(57) ABSTRACT

Embodiments of the present invention disclose apparatuses and methods for a pressure washer with 100% cool bypass operating without a soap or detergent metering valve, high pressure detergent, a booster pump, or thermal relief valve.

### BACKGROUND OF THE INVENTION

Pressure washers are typically used to clean surfaces by spraying the surfaces with a pressurized stream of fluid. The fluid is usually directed to a surface using a spray gun which is activated by a trigger. The fluid can include heated water or an aqueous mixture of chemicals, usually soap or detergent. Pressure washers generally employ either a continuously operated pump, typically driven by a gasoline motor or an electrically driven pump with a motor that can be turned on or off by a micro-switch or other electrical switch. When fluid is flowing through the spray gun, it acts to cool the pump. However, when the spray gun is not activated, fluid does not exit the spray gun even if the device is in operation. If the pump continuously operates under this condition it may result in overheating of the device. To prevent overheating prior art devices have employed either a bypass, for continuously operated internal combustion driven devices or a switch to cut off power to the device for electrically powered devices. Devices employing a bypass have been of three types. These devices utilize high pressure soap or detergent delivered upstream of the pump by a metering valve which is downstream of a cleaning solution container. Either fluid entry from the fluid source or reservoir is stopped while fluid is diverted by an unloader valve and recirculated through the system downstream of an inlet filter or the fluid is partially recirculated downstream of an inlet filter and a portion diverted to a reservoir. The former devices require a thermal relief valve, which wastes soap or detergent. The latter provide partial overheating protection but can operate in bypass mode for only a limited period of time. Alternatively some devices redirect fluid from the unloader back to the reservoir. These devices when in bypass mode continue to add soap or detergent resulting in waste of soap or detergent through a siphoning effect.

### FIELD OF THE INVENTION

The embodiments of the present invention are related to pressure washer devices which typically direct a flow of pressurized fluid through a spray gun to the surface of an object to be rinsed or cleaned and more particularly to pressure washers employing a 100% cool bypass line for directing fluid from an unloader valve to a reservoir tank, and a valve to control water influx into a water supply tank. The system can be utilized with electric or internal combustion motor and does not require a soap metering valve, a thermal relief valve, electrical cut-off switch, mixer valve or booster pump and prevents overheating of the device for extended periods of time while the spray gun is not activated.

### DESCRIPTION OF RELATED ART INCLUDING INFORMATION DISCLOSED UNDER 37 CFR 1.97 AND 1.98

Related art as discussed under the heading of “Background of the Invention” includes the partial cool bypass pressure washer disclosed in U.S. Pat. No. 8,496,188 B2 to Linton, and similar devices disclosed therein.

### BRIEF SUMMARY OF THE INVENTION

In accordance with one embodiment, the subject matter of this application includes apparatuses and methods for a pressure washer with 100% cool bypass without the need for a soap or detergent metering valve, high pressure soap, a booster pump, or thermal relief valve. A detailed description and accompanying drawing, which is incorporated and constitutes part of the specification, explain the principles of these inventions.

### BRIEF DESCRIPTION OF THE SEVERAL VIEWS OF THE DRAWING(S)

FIG. 1 is a schematic of the pressure washer device in one embodiment.

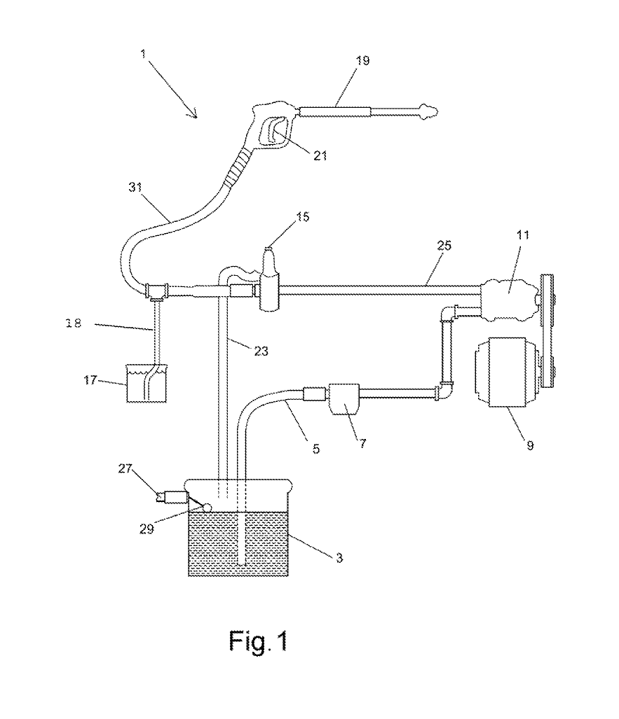

### DETAILED DESCRIPTION OF THE INVENTION

In an embodiment if the present invention water from a water source is directed to a fluid storage tank (3) through a supply hose (27). The flow of water entering the tank from the supply hose is regulated by a float valve assembly (29) to prevent overfilling the tank. Between the tank and pump (11) an in-line filter (7) is positioned to filter fluid directed toward the pump through the inlet conduit (5). The pump can be powered by a motor (9) which can be an internal combustion motor or an electric motor; the pump driven by a pulley drive system. Low pressure fluid originating from the tank is drawn by the pump and is directed through an outlet conduit (25) which extends from the pump to an unloader bypass valve (15). The outlet conduit and all other hoses and conduits can be constructed from any suitable materials. When the spray gun is activated by a user depressing the trigger, fluid is directed from the unloader valve through a high pressure hose (31) to the spray gun (19). A cleaning solution, which may be soap or detergent or other cleaning formulation is suctioned from a cleaning solution container (17). The detergent from the cleaning solution container can enter the high pressure hose from a detergent line (18) positioned to insert into the high pressure hose between the unloader bypass valve and the spray gun. Cleaning solution from cleaning solution container (17) cannot be redirected to the pump because material in the high pressure hose is exclusively directed to the spray gun (19). When the trigger is not depressed, the spray gun is deactivated causing the pressure to increase within the outlet conduit thereby activating the unloader bypass valve to direct the entire fluid stream through a bypass hose (23) which returns the fluid to the tank. The warm fluid from the bypass hose mixes with the cool fluid in the tank. Cool fluid from the tank is thereby continuously fed to the pump. Because all of the heated water from the unloader bypass valve mixes with the cool tank water, the system can operate in bypass mode for extended periods of time without overheating. Furthermore, because cleaning solution is not redirected to the pump, high pressure soap or detergent is not required.

The foregoing merely illustrates the principles of the invention. For example, a twist nozzle could be substituted for the spray gun. It thus will be appreciated that those skilled in the art will be able to devise numerous alternative arrangements that, while not shown or described herein, embody the principles of the invention and thus are within its spirit and scope.

I claim:

1. A power washer system comprising,
a water supply tank,
a pump,
a bypass valve,
a spray gun,
a pump inlet conduit having a first end associated with said water supply tank and a second end associated with said pump, configured wherein said pump inlet conduit directs a detergent-free fluid to said pump,
a pump outlet conduit having a first end associated with said pump and a second end, wherein said second end is associated with said bypass valve, and wherein said outlet conduit is in fluidic communication with said bypass valve,
a high pressure hose having a first end associated with said pump outlet conduit and said high pressure hose having a second end associated with said spray gun,
a bypass hose connecting said bypass valve to said water tank,
a cleaning solution container and a cleaning solution line, said cleaning solution line connecting said cleaning solution container to said high pressure hose at a point between said bypass valve and said spray gun,
wherein when fluid is not allowed to exit the system, up to 100 percent of the detergent-free fluid from the pump is directed by said bypass valve through said bypass hose to said water tank, and
wherein when fluid is allowed to exit the system, fluid is not directed from said bypass valve to said water tank.

2. A method of allowing an operator to generate a pressurized spray, comprising,
directing a fluid to a fluid storage tank through a supply hose,
regulating flow of said fluid entering said fluid storage tank,
drawing said fluid from said fluid storage tank via suction from a motorized pump,
filtering said fluid suctioned from said fluid storage tank with an in-line filter and directing said fluid suctioned from said fluid storage tank toward the pump through an inlet conduit,
directing fluid from said pump through an outlet conduit to an unloader valve,
selecting the direction of fluid flow from said unloader valve by an operator wherein either,
(a) the fluid flow from said unloader valve in response to said selection is directed from said unloader valve to a high pressure hose, and further wherein said cleaning solution is introduced via suction into said high pressure hose downstream from said unloader valve in response to said selection by the operator, or
(b) the fluid is directed from said unloader valve through a bypass hose thereby recirculating the fluid to said storage tank, in response to said selection by the operator.
